(19) United States
(12) Patent Application Publication
(10) Pub. No.: US 2010/0250064 A1
(43) Pub. Date: Sep. 30, 2010

(54) CONTROL APPARATUS FOR VEHICLE IN WHICH TRAVELING ENVIRONMENT RECOGNITION APPARATUS IS INSTALLED

(75) Inventors: Ryo OTA, Tokyo (JP); Mirai Higuchi, Mito-shi (JP); Jun Kubo, Tokyo (JP); Toshiya Oosawa, Yokohama-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Automotive Systems, Ltd.

(21) Appl. No.: 12/728,341

(22) Filed: Mar. 22, 2010

(30) Foreign Application Priority Data
Mar. 24, 2009 (JP) 2009-072618

(51) Int. Cl. G06F 7/00; H04N 7/18

(52) U.S. Cl. 701/36; 348/148; 348/E07.085

(57) ABSTRACT

In a control apparatus for a vehicle in which a traveling environment recognition apparatus is installed, a road shape prediction section configured to predict a road shape of a traveling road in a forward direction of the vehicle on a basis of a result of recognition by an object recognition section; a travel trajectory predicting section configured to predict a travel trajectory of the vehicle; a point of intersection calculation section configured to calculate a point of intersection between a road end of the road predicted by the road shape prediction section and a travel trajectory predicted by the travel trajectory prediction section; and a speed control section configured to control a speed of the vehicle with the point of intersection calculated by the point of intersection calculation section as a target point of place.

### BACKGROUND OF THE INVENTION

(1) Field of the Invention

The present invention relates to a technical field of a control apparatus for a vehicle in which a traveling environment recognition apparatus is installed.

(2) Description of Related Art

In a previously proposed control apparatus for an automotive vehicle, a curvature of a forwardly present curved road is calculated from a node point row obtained from a road map data base of a navigation system and a vehicle speed control is carried out in accordance with a calculated curved road curvature. One example related to this technique is described in Society of Automotive Engineers of Japan academic lecture meeting manuscripts No. 54-08(P9-12).

### SUMMARY OF THE INVENTION

There are many industrial demands for the vehicle control apparatus which can predict a road shape with a high accuracy without dependency upon a navigation system.

It is, therefore, an object of the present invention to provide a control apparatus for a vehicle in which a traveling environment recognition apparatus is installed, both of the control apparatus and traveling environment recognition apparatus being capable of predicting the road shape with a high accuracy.

According to a first aspect of the present invention, there is provided a control apparatus for a vehicle in which a traveling environment recognition apparatus is installed, comprising: a traveling road state detection section configured to detect a state of a traveling road in a forward direction of the vehicle; an object recognition section configured to recognize at least a presence of an object on the traveling road from a detection result of the traveling road state detection section; a road shape prediction section configured to predict a road shape of the traveling road in the forward direction of the vehicle on a basis of a result of recognition by the object recognition section; a travel trajectory predicting section configured to predict a travel trajectory of the vehicle; a point of intersection calculation section configured to calculate a point of intersection between a road end of the road predicted by the road shape prediction section and a trajectory predicted by the travel trajectory prediction section; and a speed control section configured to control a speed of the vehicle, with the point of intersection calculated by the point of intersection calculation section as a target point of place.

According to a second aspect of the present invention, there is provided a control apparatus for a vehicle in which a traveling environment recognition apparatus is installed, wherein the traveling environment recognition apparatus comprises: a road state recognition section configured to recognize a presence of a white line or an object located aside a traveling road in a forward direction of the vehicle; a reliability determination section configured to determine a reliability of a result of recognition by the road state recognition section; and a road shape prediction section configured to predict a road shape on the traveling road located in the forward direction of the vehicle on a basis of the information from the road state recognition section in a case where the reliability determined by the reliability determination section is lower than a predetermined reliability.

According to a third another aspect of the present invention, there is provided a control apparatus for a vehicle in which a traveling environment recognition apparatus is installed, the traveling environment recognition apparatus including: a stereo camera configured to photograph at least a white line present on a traveling road in a forward direction of the vehicle; a road shape prediction section configured to predict a road shape on a basis of an image photographed by the stereo camera, the road predicting section predicting the road shape on a basis of the image photographed by the stereo camera and a result of prediction by the road shape prediction section; a travel trajectory prediction section configured to predict a travel trajectory of the vehicle; a point of intersection calculation section configured to calculate a point of intersection between a road end of the road predicted by the road shape prediction section and the projected trajectory by the travel trajectory prediction section; and a control section configured to control the speed of the vehicle with the point of intersection calculated by the point of intersection calculation section as a target point of place.

According to a fourth aspect of the present invention, there is provided a control apparatus for a vehicle in which a traveling environment recognition apparatus is installed, wherein the traveling environment recognition apparatus including:

a road state recognition section configured to recognize a presence of a white line or an object located aside a traveling road in a forward direction of the vehicle; a reliability determination section configured to determine a reliability of a result of recognition by the road state recognition section; and a road shape prediction section configured to predict a road shape on the traveling road located in the forward direction of the vehicle on a basis of the information from the road state recognition section in a case where the reliability determined by the reliability determination section is lower than a predetermined reliability;

According to a fifth aspect of the present invention, there is provided a control apparatus for a vehicle in which a traveling environment recognition apparatus is installed, the control apparatus comprising: the traveling environment recognition apparatus including: a point of intersection calculation section configured to calculate a point of intersection between an end of the road predicted by the road shape prediction section and a trajectory predicted by a travel trajectory prediction section; and a speed control section configured to control a speed of the vehicle with a point of intersection calculated by the point of intersection calculation section as a target point of place, wherein the road shape prediction section includes an object of deceleration detection section configured to detect an object of deceleration and the speed control section executes a deceleration control to calculate a target deceleration from a present vehicle speed and the target point of place in a case where the object of deceleration is detected by the object of deceleration detection section; a point of intersection calculation section configured to calculate a point of intersection between an end of the road predicted by the road shape prediction section and a trajectory predicted by a travel trajectory prediction section; and a speed control section configured to control a speed of the vehicle with a point of intersection calculated by the point of intersection calculation section as a target point of place, wherein the road shape prediction section includes an object of deceleration detection section configured to detect an object of deceleration and the speed control section executes a deceleration control to calculate a target deceleration from a present vehicle speed and the target point of place in a case where the object of deceleration is detected by the object of deceleration detection section.

### BRIEF DESCRIPTION OF THE DRAWINGS

FIG. 1 is a system configuration view of a vehicle to which a control apparatus and a traveling environment recognition apparatus is installed in a first preferred embodiment according to the present invention is applicable.

FIG. 2 is an explanatory view for explaining a principle of photographing an image on a stereo camera using a triangulation.

FIG. 3 is a control block diagram of the control apparatus in the first embodiment shown in FIG. 1.

FIG. 4 is a flowchart representing a flow of a vehicle control processing executed in the first embodiment shown in FIG. 1.

FIG. 5 is a flowchart representing a flow of a detection accuracy determination processing in the first preferred embodiment shown in FIG. 1.

FIGS. 6A and 6B are graphs representing a method of calculation of a reliability coefficient in accordance with a number of white line detection points.

FIGS. 7A and 7B are graphs representing a method for the calculation of reliability coefficient in accordance with a correlation coefficient of a regression curve that the range of the white line detection points constitutes.

FIGS. 8A, 8B, and 8C show graphs representing a method for calculating the reliability coefficient in accordance with a magnitude of deviations of the heights of the range of white line detection points.

FIG. 9 is an explanatory view for explaining a curvature complement method of a white line in a non-detection interval.

FIG. 10 is an explanatory view for explaining a method for a straight line complement method of the white line in the non-detection interval.

FIG. 11 is a flowchart representing a flow of a road shape estimation processing.

FIG. 12 is a flowchart representing a detailed flow of a white line complement processing at a step S31 shown in FIG. 11.

FIG. 13 is an explanatory view for explaining a method for calculating a point of collision.

FIG. 14 is an explanatory view for explaining the point of calculating the point of collision from among candidates of the point of collision.

FIG. 15 is a flowchart representing a flow of a point of collision calculation processing.

FIG. 16 is a flowchart representing a flow of the road shape determination processing utilizing a fact that a white line data has a positional information on a three-dimensional space.

### DETAILED DESCRIPTION OF THE INVENTION

Various forms to achieve a control apparatus for an automotive vehicle in which a traveling environment recognition apparatus is installed will hereinafter be described with reference to accompanied drawings in order to facilitate a better understanding of the present invention. The preferred embodiments as will be described hereinbelow have been discussed to meet many industrial requirements for the control apparatus for the automotive vehicle in which the traveling environment recognition apparatus is installed and to be applicable to many industrial requirements and to be capable of increasing a prediction accuracy of a road shape is one of the industrial requirements for the control apparatus for the automotive vehicle in which the traveling environment recognition apparatus is installed.

### First Embodiment

### [Whole Configuration]

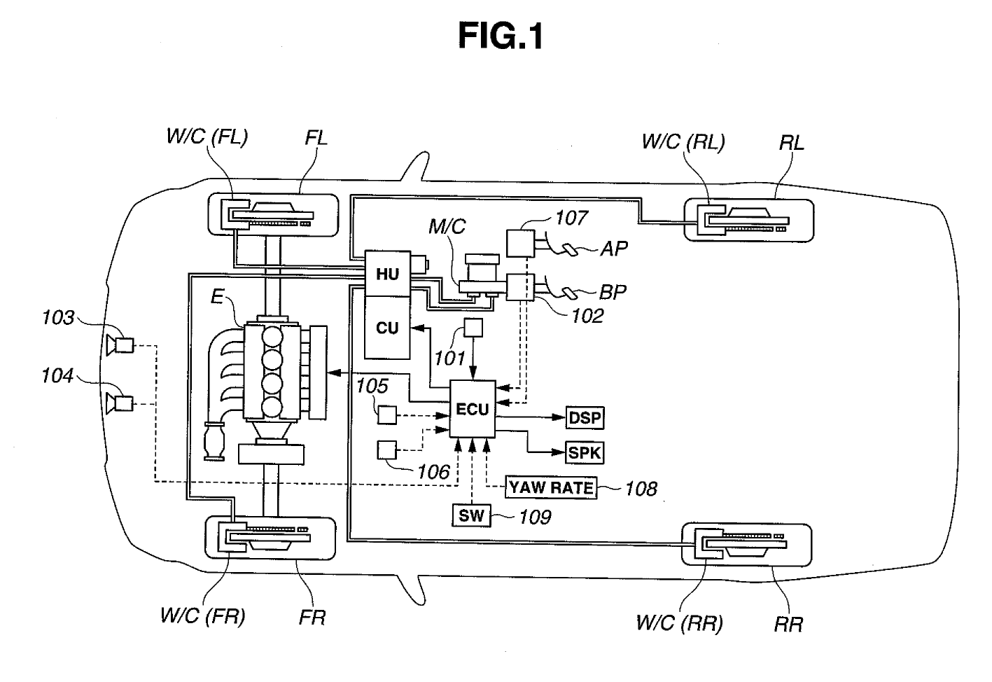

FIG. 1 shows a system configuration view of an automotive vehicle to which a control apparatus for a vehicle in which a traveling environment recognition apparatus is installed in a first preferred embodiment according to the present invention is applicable.

The automotive vehicle in the first preferred embodiment includes a brake-by-wire system (hereinafter, abbreviated as BBW) as a brake apparatus. A control unit ECU inputs a master cylinder pressure from a master cylinder pressure sensor 101 and a brake pedal stroke from a brake pedal stroke sensor 102. A control unit CPU calculates a target liquid pressure (P*FL, P*FR, P*RL, and P*RR) for each of road wheels FL (Front Left road wheel), FR (Front Right road wheel), RR (Rear Right road wheel), and RL (Rear Left road wheel) to perform a control for a hydraulic pressure control unit CU. A liquid pressure control unit HU supplies a brake liquid for wheel cylinders W/C (W/C(FL), W/C(FR), W/C(RR), and W/C(RL)) for respective road wheels FL, FR, RR, and RL from a master cylinder M/C in accordance with an operation of hydraulic pressure control unit CU.

Control unit (ECU) inputs photographed images from two cameras 103, 104 constituting the stereo camera, a steering angle from a steering angle sensor 105, a speed of a vehicle (hereinafter, also referred to as a vehicle speed) from a vehicle speed sensor 106, an accelerator opening angle from an accelerator opening angle 107, and a yaw rate from a yaw rate sensor 106. Control unit ECU detects and predicts a road shape on a traveling road in a vehicular forward direction and performs an alarm for vehicular occupants of a vehicle (the vehicle means a vehicle itself in which the speed control apparatus and the traveling environment recognition apparatus is mounted) on a basis of the road shape of the traveling road in the vehicular forward direction and a traveling state of the vehicle.

In the first embodiment, a brake control (a deceleration control) utilizing the BBW system and an engine braking of an engine E. In addition, as the alarm, a display by means of a display DSP and an issuance of a warning through a speaker SPK are carried out.

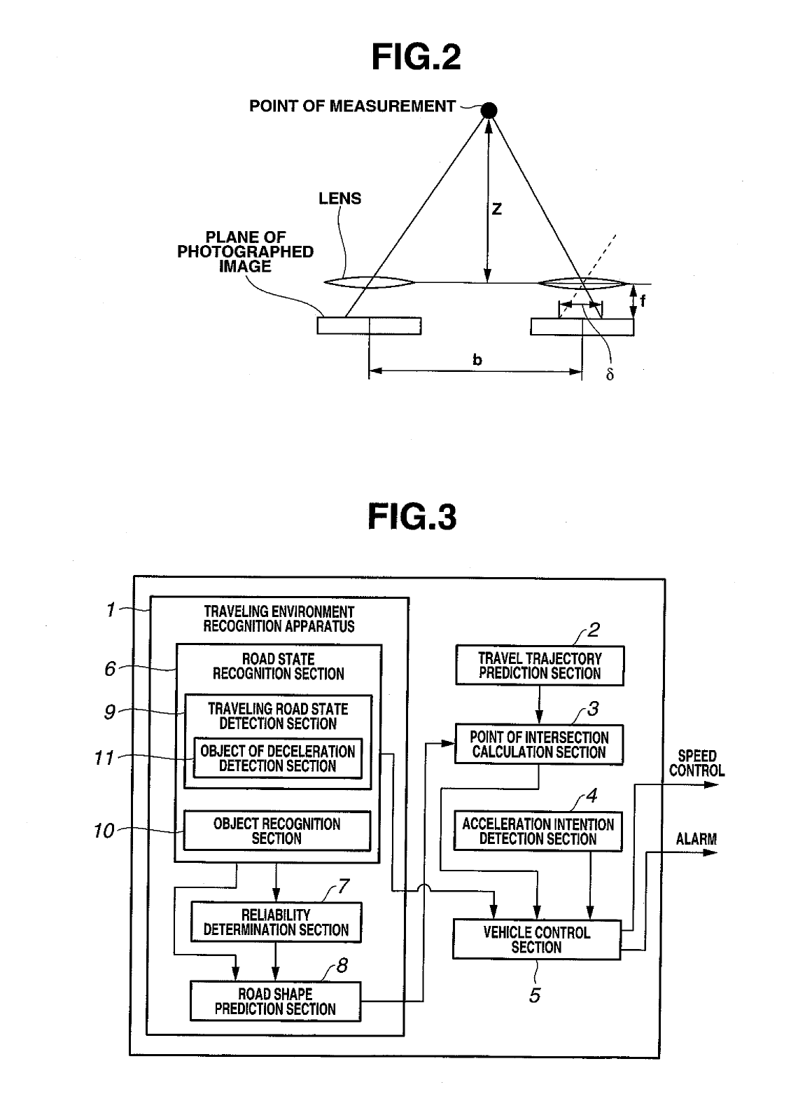

FIG. 2 is an explanatory view representing a principle of operation of the stereo camera. In the stereo camera, when two cameras 103, 104 are used to photograph the same point of measurement, a distance from a position of the stereo camera (a lens position of each of two cameras 103, 104) to the point of measurement can be measured on a basis of a principle of a triangulation using a parallax generated between the two photographed images. For example, supposing that distance from the lens of cameras 103, 104 to the point of measurement is Z [mm], the distance between two cameras 103, 104 is b[mm], a focal distance of each lens of two cameras 103, 104 is f[mm], and a parallax is δ [mm], distance Z to the point of measurement can be determined in the following equation (1).

Z=(b×f)/δ (1)

[Structure of Vehicle Control Apparatus]

FIG. 3 is a control block diagram of the vehicle control apparatus in the first embodiment. This vehicle control apparatus is a program executed by a CPU (Central Processing Unit) of control unit ECU except a part of the structure of the vehicular control apparatus. Vehicle control apparatus in the first embodiment includes: a traveling environment recognition apparatus 1; a travel trajectory prediction section 2; a point of intersection calculation section 3; an acceleration intention detection section 4; and a vehicle control section 5.

Traveling environment recognition apparatus 1 includes: a road state recognition section configured to detect a white line in the forward direction of the vehicle or an object located aside the road; a reliability determination section 7 configured to determine a reliability of a result of recognition of a road state recognition section 6; and a road shape prediction section 8 configured to predict a road shape of the traveling road in the forward direction of the vehicle on a basis of information in the forward direction of information on the road state recognition section 6 in a case where a reliability of a result of recognition by road state recognition section 6 determined by reliability determination section 7 is low.

Road state recognition section 6 includes a traveling road state detection section 9 and an object recognition section 10. Traveling road state detection section 9 is the stereo camera described above (two cameras 103, 104) configured to detect a state of the traveling road in the forward direction of the vehicle. This road state recognition section 6 includes an object deceleration section configured to detect an object of deceleration of the vehicle on a basis of the photographed images. The object of deceleration includes a curved road, a traffic intersection, an obstacle, and so forth.

Object recognition section 10 recognizes a presence of an object on the traveling road (a white line, a guard rail on a traveling road, a marker, and so forth) from a result of detection of traveling road state detection section 9.

Reliability determination section 7 determines the reliability which indicates a height of the reliability of the result of recognition by object recognition section 10. Road state prediction section 8 predicts the vehicular forward traveling road on a basis of the reliability of travel trajectory of the vehicle on a basis of a result of recognition of object recognition section 10 and the reliability determined by reliability determination section 7. Travel trajectory prediction section 2 predicts the travel trajectory on a basis of the vehicle speed, the steering angle, and the yaw rate.

Point of intersection calculation section 2 calculates a point of intersection (a point of collision) between a road end predicted by road shape prediction section 8 and a travel trajectory of the vehicle predicted by travel trajectory prediction section 2.

Acceleration intention detection section 4 detects an intention of a vehicle driver on a basis of an accelerator opening angle (or an opening angle of an accelerator pedal). Acceleration intention detection section 4 detects the acceleration intention by the vehicle driver when the accelerator opening angle is equal to or wider than a predetermined value.

Vehicle control section 5 carries out a control over the vehicle such as a deceleration control with a point of intersection calculated by means of point of intersection calculation section 3 as a target point or the alarm to the vehicle driver. At this time, in a case where the acceleration intention by the vehicle driver is detected, the deceleration control is not carried out but a priority is is taken for the acceleration intention by the vehicle driver.

[Vehicle Control Processing]

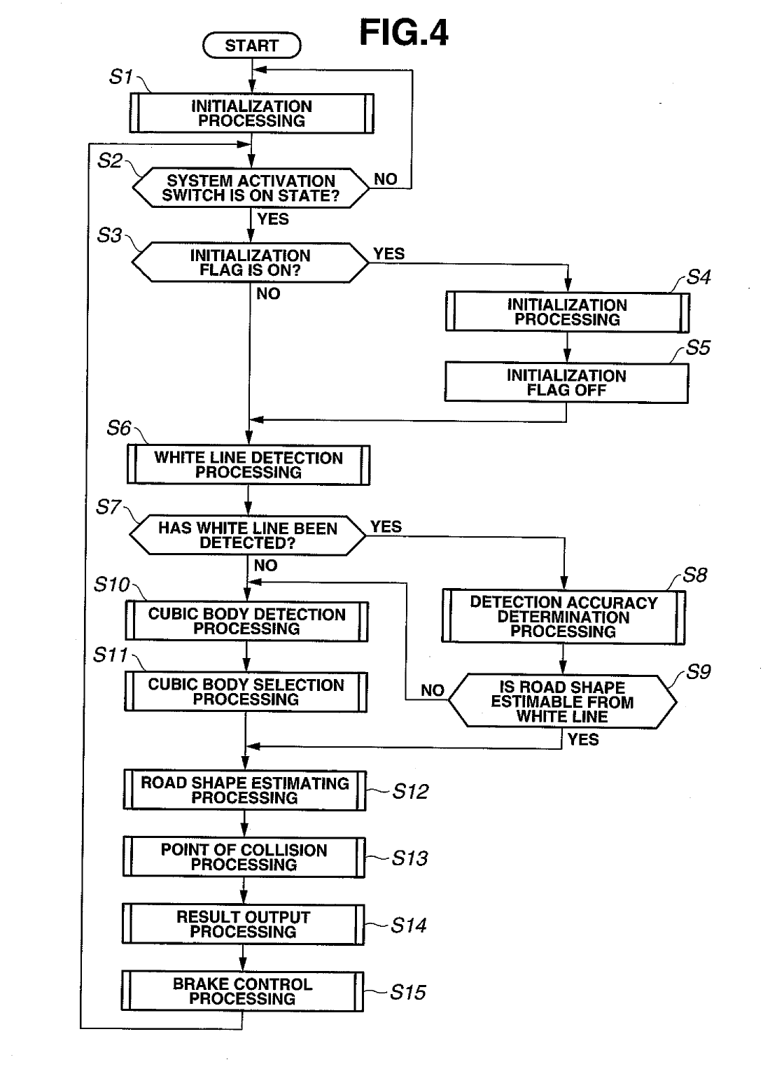

FIG. 4 is a flowchart representing a flow of a vehicle control processing in the first embodiment. Hereinafter, each step will be described. It should be noted that this processing is started with an ignition switch as a start trigger and executed until the ignition switch is turned to OFF.

At a step S1, an activation switch 109 of a system is turned to ON and the initialization flag is set to ON. Then, the routine goes to step S2.

At a step S2, a determination of whether activation switch 109 of the system is turned to ON is made. If Yes (the activation switch of the system is turned to ON), the routine goes to a step S3. If No, the routine goes to a step S1. Activation switch 109 is a switch to select whether the brake control in accordance with the road shape of the traveling road in the forward direction of the vehicle should be executed.

At a step S3, a determination of whether the initialization flag is set or not is made. If Yes, the routine goes to a step S4. If No, the routine goes to a step S6.

At a step S4, an initialization processing of the vehicle control apparatus is carried out. Then, the routine goes to a step S5. At step S5, an initialization flag is cleared (OFF) and the routine goes to a step S6. At step S6, a white line detection processing is carried out to detect the white line on a basis of the photographed images of cameras 103, 104 and the routine goes to a step S6. The details of the white line detection processing will be described in details below.

At a step S7, the system determines whether the white line as the result of the white line processing has been detected. If Yes, the routine goes to a step S8.

If No at step S7, the routine goes to a step S10.

At step S8, reliability determination section 7 calculates a reliability of the detection of white line and carries out the detection accuracy determination processing in which the white line having the reliability equal to or higher than the predetermined reliability is assumed to be the white line is the routine goes to step S9. It should be noted that the details of the detection accuracy determination processing will be described later.

At step S9, control unit ECU determines whether, in road shape prediction section 8, the road shape can be estimated from the detected white line. If Yes, the routine goes to a step S12. If No at step S9, the routine goes to a step S10.

At step S10, control unit ECU carries out a cubic body (a three-dimensional body) detection processing to detect the three-dimensional body such as a parked vehicle, a preceding vehicle, a curb, a tree, the guard rail, the marker, and so forth present on the traveling road on a basis of the photographed images of cameras 103, 104 and the routine goes to a step S11.

At step S11, control unit ECU carries out a three-dimensional body selection processing such that a fixture such as the curb, the guard rail, the marker, or so forth is selected (extracted) from among the cubic bodies detected by the three-dimensional body detection processing, in object recognition section 10, in other words, control unit ECU eliminates the parked vehicle(s), the preceding vehicle(s), and a pedestrian or so forth which are difficult to be contributed on the prediction of the road shape. Then, the routine goes to a step S12.

At step S12, a road shape estimation processing is carried out by road shape prediction section 8 on a basis of the white line or on a basis of the white line and the three-dimensional body. Then, the routine goes to a step S13. The details of the road shape estimation processing will be described hereinbelow.

At a step S13, control unit ECU executes, in the point of intersection calculation section 3, a point of collision calculation processing to calculate a point of collision between the projected travel trajectory of the vehicle and a shoulder (or an end) of the road for a road region estimated by the road shape estimation processing is carried out and the routine goes to a step S14. The details of the point of collision calculation processing will be described later.

At a step S14, control unit ECU carries out (or executes) a result output processing such as to output an image of the curved road or the obstacle to display DSP and to issue the alarm for the vehicle driver, in a case where the curved road is present on the traveling road in the forward direction of the vehicle or in a case where the obstacle is detected by object of deceleration detection section 11. Then, the routine goes to a step S15. It should be noted that the details of the result output processing will hereinafter be described.

At step S15, control unit ECU executes the brake control processing to decelerate the vehicle in accordance with the point of collision calculated by the point of intersection calculation section 3 and the obstacle detected by the object of deceleration detection section 11 is carried out. Then, the routine returns to step S2. The details of the brake control processing will, hereinafter, be described.

Hereinafter, the details of the white line processing at step S6, the detection accuracy determination processing at step S8, the point of collision calculation section at step S13, the result output processing at step S14, and the brake control processing at step S15 will be described in details.

(White Line Detection Processing)

In the white line processing, the white line painted on the traveling road on a basis of the photographed images by cameras 103, 104 is detected. The white line to be detected includes: a block line partitioning a traveling traffic lane on which the vehicle is traveling and an adjacent traffic lane to the traffic lane and a center line painted on the traveling traffic lane of the vehicle. A method of detecting the white line from the photographed images by the cameras 103, 104 may be arbitrary from among various well known methods. It should be noted that the line painted on the traveling road is not only in white but also, for example, in orange color. In the first embodiment, for an explanation convenience, each of the lines painted on the traveling road will be explained as the white line.

The white line detected on the image provides a white line data having a positional information on a three-dimensional space by superposing the distance information on the white line obtained on the image. Thus, it becomes possible to estimate a road surface gradient.

(Detection Accuracy Determination Processing)

In the detection accuracy determination processing, a reliability of the white line as a whole or partial region is calculated due to a continuity or smoothness to a region which is determined to be the white line in the white line detection processing, an articulation of a boundary between the regions which are determined to be the white line and to be the road surface, a deviation of the region which is determined to be the white line from the region which is determined to be the road surface, and other factors. Then, only the regions which have reliabilities equal to or higher than a predetermined reliability from among the regions in which the white lines have been detected provide the white line data used for the prediction of the road shape. For example, in a case where the region which is determined to be the white line region from the images is present at an unnatural position with respect to the regions estimated as the road surface on the three-dimensional space, the corresponding region is eliminated from the white line data so that the reliability can be increased. In addition, from the distance information obtained by cameras 103, 104, a white line recognition accuracy can be increased by extracting the region in which the white line on the road surface may be present by extracting any region over which the distance information is linearly distributed.

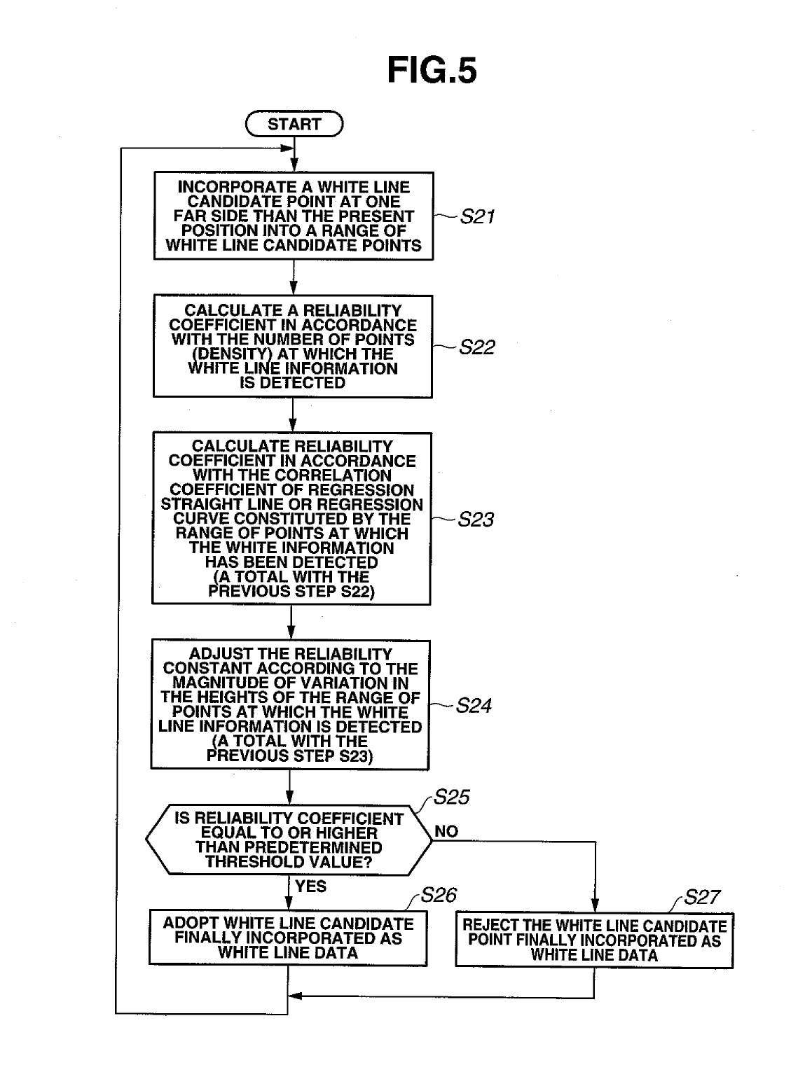

FIG. 5 shows a flowchart representing a flow of the detection accuracy determination processing in the first embodiment and each step shown in FIG. 5 will be described hereinbelow.

At a step S21 in FIG. 5, control unit ECU incorporates the white line candidate point at one far side (more forward direction) from the present position into a range of the white line candidate points. Then, the routine goes to a step S22.

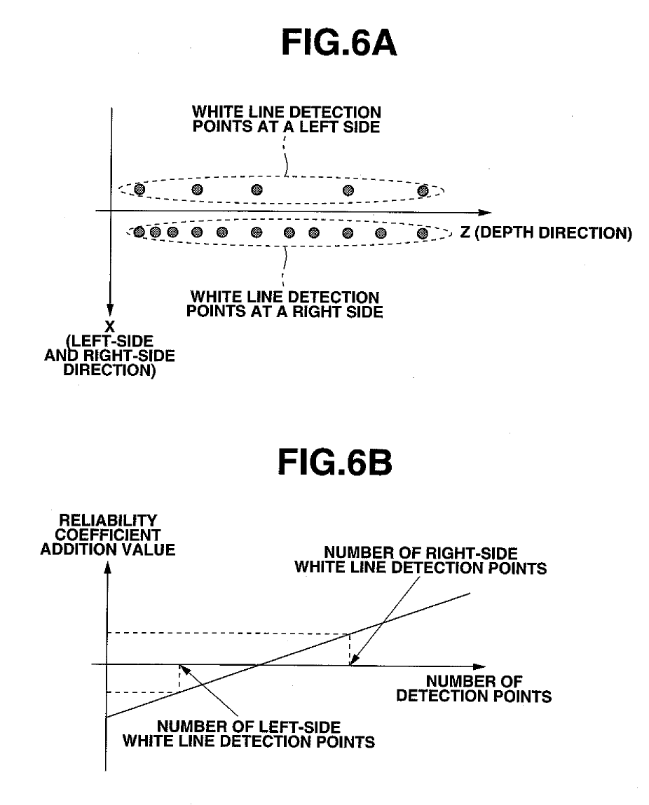

At step S22, control unit ECU calculates a reliability coefficient (a reliability coefficient addition value) in accordance with the number of points (a density) on which the white line information is detected and the routine goes to a step S23. For example, in an example of FIG. 6A, since the number of the detection points of the white line at a right side is larger than the number of the detection points of the white line at a left side, control unit ECU determines that the detection accuracy at the right side is higher than the detection accuracy at the left side and sets the right-side reliability coefficient addition value to be higher than the left-side reliability coefficient addition value (as shown in FIG. 6B).

At step S23, control unit ECU calculates the reliability coefficient (a reliability coefficient addition value) in accordance with a correlation coefficient of a regression line or a regression curve constituted by the range of points on which the white line information is detected and sums up with the reliability coefficient addition value that has been calculated at step S22.

Then, the routine goes to a step S24.

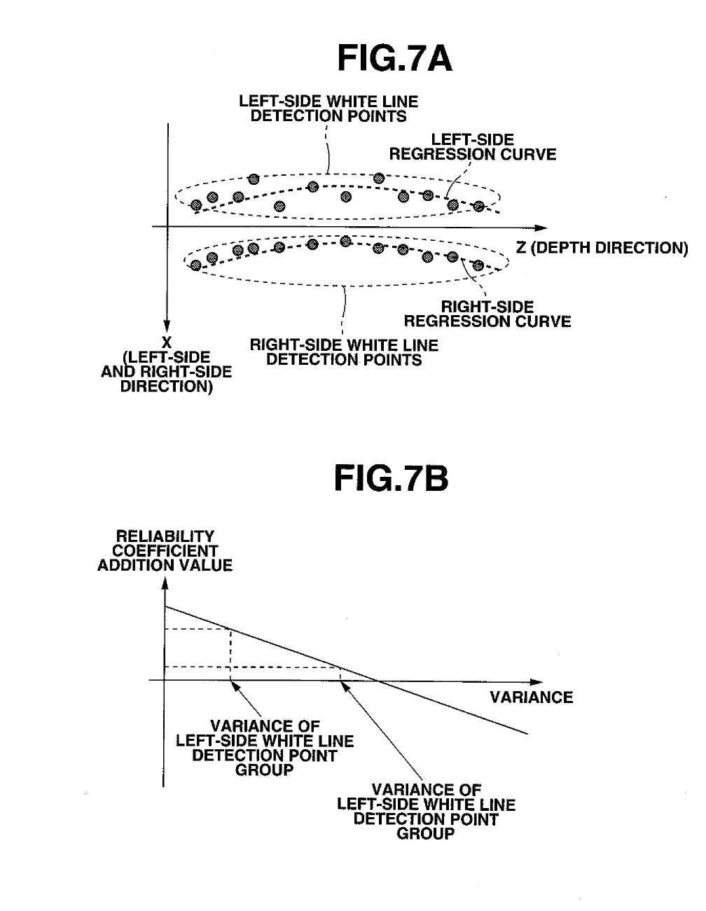

For example, in an example of FIG. 7A, since a variance of the right-side white line detection point with respect to the right-side regression curve is smaller than the variance of the left-side white line detection point, the right-side white line detection point is more approximate to the regression curve than the left-side regression line, control unit ECU determines that the right-side white line detection accuracy is higher than the left-side white line detection accuracy and sets the reliability coefficient addition value of the right-side white line detection point to be higher than the reliability coefficient addition value at the left-side white line detection point as shown in FIG. 7B.

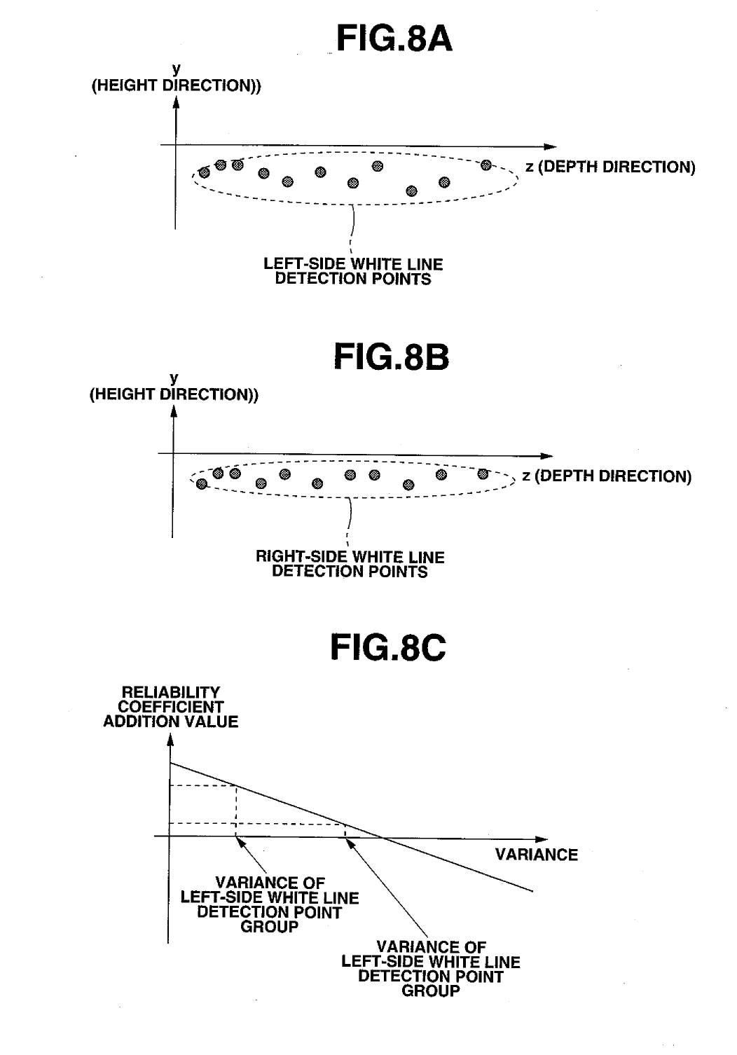

At step S24, control unit ECU calculates the reliability coefficient (the reliability coefficient addition value) according to a magnitude of a variation in heights of the range of points on which the white line information is detected, sums up with the reliability coefficient addition value that has been calculated at step S23 to calculate a final reliability coefficient. Then, the routine goes to a step S25. For example, in an example of FIG. 8A, since control unit ECU determines that the variation in the heights of the right-side white line detection points is smaller than the variation in the heights of the left-side white line detection points and determines that the right-side white line detection accuracy is higher than the left-side white line detection accuracy and sets the reliability coefficient addition value of the right-side white line detection points to be higher than that of the left-side white line detection points, as shown in FIG. 8B.

At step S25, control unit ECU determines whether the reliability coefficient calculated at step S24 is equal to or higher than a predetermined threshold value. If Yes at step S25, the routine goes to a step S26. If No at step S25, the routine goes to a step S27.

At step S26, a white line candidate point finally incorporated (a white line candidate point incorporated at step S21 within the same control period) is adopted as a white line data and the routine goes to a step S21.

At step S27, control unit ECU eliminates the finally incorporated white line candidate point from the white line data and the routine goes to step S21.

In the flowchart of FIG. 5, since the flow through step S21→step S22→step S23→step S24→to step S26 is repeated so that the white line candidate point at one far side than the present position is incorporated into the range of the white line candidate points. When the reliability coefficient becomes lower than the predetermined threshold value, the flow through step S21→step S22→step S23→step S24→step S25→step S27 so that the white line candidate points to be finally incorporated are not entered into the white line data. Thus, the white line data can be constituted by the range of the white line candidate points when the reliability coefficient maintains at values equal to or higher than the predetermined threshold value. In other words, the white line data is constituted by only the range of the white line detection points having high reliability from which the white line detection points having the low reliabilities are eliminated (or rejected).

(Road Shape Estimation Processing)

In the road shape estimation processing, the white line data of an interval in which the white line is not detected due to a remote location of the white line at which the white line data could not be obtained and (, hereinafter, referred also as to a non-detection interval) is complemented on a basis of the white line data of another interval at which an neighboring white line has been detected (the interval at which the white line data has been obtained and, hereinafter, referred as to a detection interval) and the road shape (a road region) of the traveling road in the forward direction of the vehicle can be estimated on a basis of the complemented white line data and the three-dimensional body (the three-dimensional object). It should, herein, be noted that, in a case where the white line at a near position to the vehicle is detected, only at one of the left-side white line and the right-side white line which an information, a lane width is estimated from the information of a region in which both sides of the left-side and right-side white lines have been detected.

Thus, a white line position which is not yet detected can be estimated.

It is sufficient to carry out the complement of the white line data until a position which provides the point of collision to be used in the brake control.

However, the point of collision cannot be calculated after the complement (after the white line is actually extended). Hence, it is difficult to determine up to which distance the white line should be extended before the calculation of the point of collision.

Therefore, in the first embodiment, a distance to a degree such that, from the viewpoint of control, at the present stage, a determination that it is unnecessary to recognize the presence of the curved road can be made is given as a fixed value or a value varied in accordance with a vehicle speed and an extension is made up to the above-described distance.

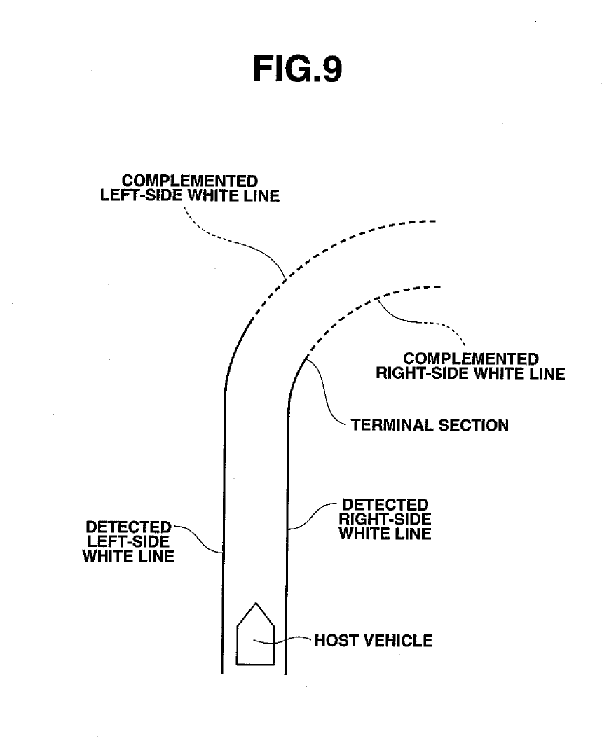

The complement method such that, as shown in FIG. 9, a curvature of a part of the white line which is most remotely located from the vehicle in the detection interval is calculated and the white line in the non-detection interval is complemented using the calculated curvature can be used. It should, herein, be noted that, as a curve based on the calculation of the curvature, a part of curve most remotely located terminal section in the detection interval may directly be used. A plurality of curvatures at a plurality of locations in the detection interval may be calculated, weight means for those at the terminal sections may be calculated and the most terminal sections thereof may directly be calculated. The method of this complement may be arbitrary. Or alternately, in place of the calculations of the curvature, an equation of the curve which matches with the shape of the detection interval may be calculated and an extension of the white line in the non-detection internal may be made on a basis of the curve given by this equation. It should be noted that the equation providing the curve may be polynomial but not specifically be limited.

In addition, with the curve of the road constituted by a shape varied from a straight line to an arc via a relaxation curve as a premise, the detection interval is assumed as an alignment changed from the straight line to the relaxation curve and this detection interval is applied to the shape presenting the relaxation curve and the non-detection interval may be complemented as an extension of the relaxation curve. A method of applying the curve onto the non-detection interval is such that the obtained white line data is projected onto coordinates and a combination of coefficients which meet best with the white line data for the numerical equations to be drawn onto the coordinate space is calculated through a method of least squares. As the relaxation curve, a clothoid curve (for the details of the clothoid curve, refer to a U.S. Pat. No. 7,555,385 issued on Jun. 30, 2009, the disclosure of which is herein incorporated by reference), a cubic, or a sinusoidal half-wavelength reduction curve may be used but the present invention is not limited to these curves.

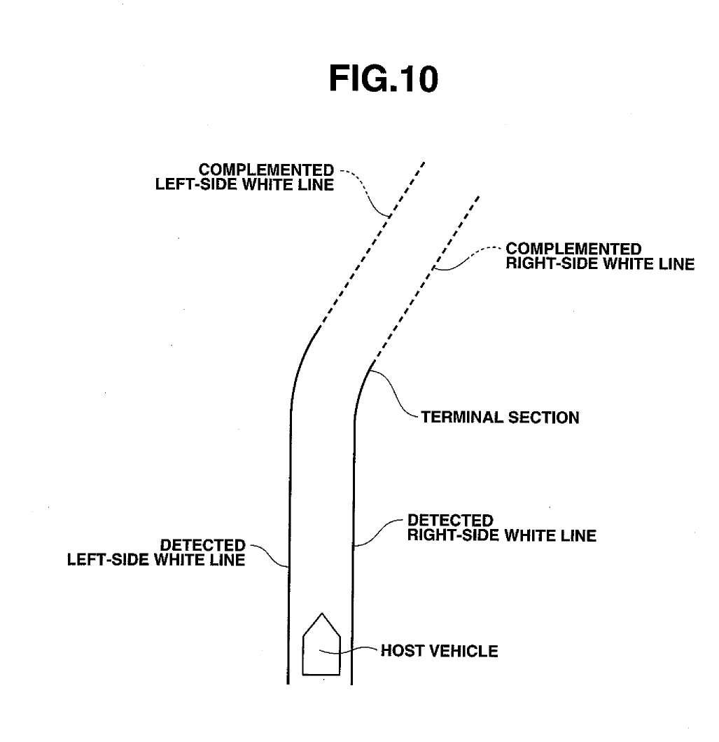

In addition, the white line shape in the detection interval is applied to the curve expressed in a multi-dimensional expression equal to or larger than a two-dimensional expression or represented by other numerical equations and the non-detection interval may be complemented in a form of the extension of the curve. In this case, if the terminal section of the detection interval is of an arc shape, a portion of the relaxation curve is already ended at the detection interval and is assumed to be entered into the arc interval and is complemented directly in the form of arc at the curvature of the terminal section. It should, herein, be noted that, as shown in FIG. 10, a linear complement (or a linear interpolation) may be carried out with a gradient of the detection interval terminal section held. If the linear complement is carried out, as compared with a case of the curve complement, the curve is deemed to be gentle. Under a situation in which the reliability is low, an erroneous operation as the brake control based on the curved road and the unnecessary alarm issuance can be reduced.

On the other hand, in a case where the white line is not detected any more as a present instantaneous information, the road shape prediction is carried out from the information of the white line detected at past. This road shape prediction is carried out because the white line information obtained at past and the road shape prediction information based on the white line information obtained at past serve to estimate how long the vehicle has been relatively moved as viewed from the vehicle speed and the road shape prediction information based thereon and is consequently outputted as a present estimated road shape. The road shape prediction information based on the white line information obtained at the past and the road shape prediction information is to estimate how long distance the vehicle has moved relatively as viewed from the vehicle and its result is outputted as the present estimation road shape. The use of the white line information detected at past permits a prevention of an extreme variation in the result of prediction of the road shape against a temporal detection failure state.

Furthermore, even in a case where the white line is not detected any more at the present time and at the past immediately before, the road shape prediction does not become impossible but the road shape prediction is carried out only through the three-dimensional body information. At this time, even in a case where the white line is detected at the present time or at past immediately before, the three-dimensional body information is used for the road shape estimation in a case where the reliability of the white line is low. It should be noted that a detection of a texture present on the road surface causes a road surface position to be estimated and a road surface region may be specified by a search for a distribution of feature points present on the same flat surface. In this case, a region in which the feature point largely different from a height which is deemed to be the road surface is determined to be out of a road surface region so as to enable the assisting of a road surface region determination. In addition, as a countermeasure in a case where a quantity of feature representing the road shape is deficient such as a snow road, a delineator which clearly indicates a shoulder of a road such as features of an arrow or a snow-pole installed on the shoulder of road is detected and this may estimate the road shape.

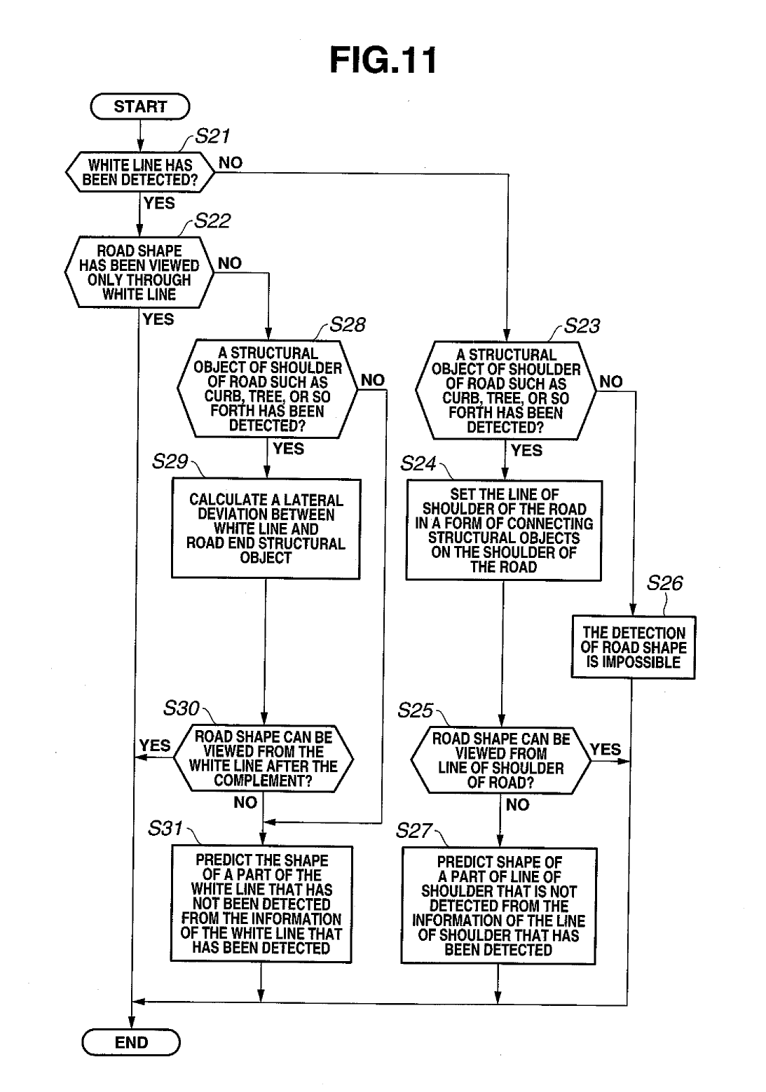

FIG. 11 shows a flowchart representing the road shape estimation processing. Each step shown in FIG. 11 will be explained hereinbelow.

At a step S21, control unit ECU determines whether the white line has been detected. If Yes at step S21, the routine goes to a step S22. If No at step S21, the routine goes to a step S23.

At step S22, control unit ECU determines whether the road shape can be viewed only through the white line. If Yes, the present routine is ended. If No at step S22, the routine goes to a step S28.

At step S23, control unit ECU determines whether a structural object on a shoulder of road (or a road end) such as curb, tree, or so forth has been detected.

If Yes at step S23, the routine goes to a step S24. If No at step S23, the routine goes to a step S26.

At step S24, control unit ECU sets a line of a shoulder of a road in a form in which the structural objects are interconnected and the routine goes to a step S25.

At step S25, control unit ECU determines whether the road shape can be viewed from the set line of shoulder of the road.

If Yes at step S25, the present routine is ended. If No at step S25, the routine goes to a step S27.

At step S26, control unit ECU determines that the detection of the road shape cannot be carried out and the present control (routine) is ended. If the road shape cannot be detected, vehicle control section 5 does not (inhibits) execute the brake control. It should be noted that the driver may be informed that the road shape cannot be detected through display DSP or through speaker SPK.

At step S27, control unit ECU predicts the shape of another line of the shoulder of the road that has not been detected from the information of the line of shoulder that has been detected. Then, the present control is ended.

At step S28, control unit ECU determines whether at least one of the structural objects of the shoulder of the road has been detected. If Yes, the routine goes to a step S29. If No, the routine goes to a step S31.

At step S29, control unit ECU calculates a lateral positional deviation between the white line and the detected structural object on the shoulder of the road and complements the white line from the structural object of the shoulder of the road.

Then, the routine goes to a step S30.

At step S30, control unit ECU determines whether the road shape can be viewed from the white line after the complement. If Yes at step S30, the present routine is ended. If No at step S30, the present routine goes to a step S31.

At step S31, control unit ECU predicts the shape of a part of the white line which is not detected from the information of the white line that has been detected and the present routine is ended.

In a case where the white line is detected and the road shape can be viewed only through the white line, the flow from step S21→S22 is resulted and no complement of the white line is carried out.

In a case where the road shape cannot be viewed only though the white line although the white line is detected, the routine goes from step S21→step S22→step S28→step S29 when the structural objects of the shoulder of road are detected. In this case, the white line is complemented from the structural objects. When the structural objects on the shoulder of road are not detected and when the road shape cannot be viewed although the white line is complemented from the structural object on the shoulder of road, the flow from step S21→step S23→step S24 is carried out or the flow from step S21→step S22→step S28→step S29→step S30→step S31 is resulted. Thus, the shape of a part of the white line that has not been detected is predicted from the information of the white line that has been detected.

On the other hand, in a case where the white line is not detected but the structural object of the shoulder of the road is detected, the flow of step S21→step S23→step S24 is advanced. Thus, the line of shoulder of road is set in the form connecting the structural objects on the shoulder of the road. If the road shape is not viewed from the line of shoulder of road, the routine shown in FIG. 11 goes to step S27 and control unit ECU predicts the shape of the road that is not detected from the information of the line of shoulder of road that has been detected.

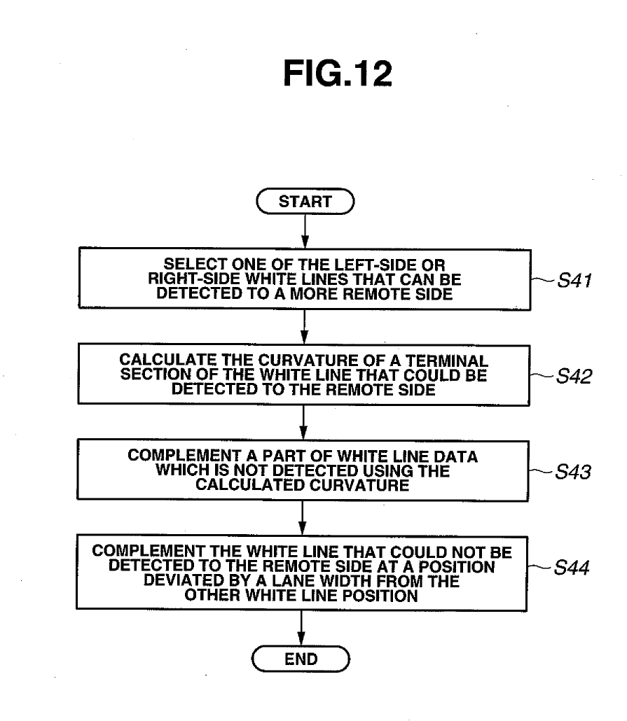

FIG. 12 is a flowchart representing a flow of the white line complement processing at step S31 shown in FIG. 11.

At a step S41, control unit ECU selects one of the left-side and right-side white lines which could have been detected to a more remote position and the routine goes to a step S42.

At step S42, control unit ECU calculates the curvature of the terminal section of the white line which has been selected at step S41 and the routine goes to a step S43.

At step S43, control unit ECU uses the curvature calculated at step S42 to complement the white line data at a part of the white line which has not been detected and the routine goes to a step S44.

At step S44, control unit ECU complements the other white line which has not been detected up to the more remote position of the one white line at a position deviated from a position of the other of the left-side and right-side white lines by the lane width and the present routine is ended. It should be noted that the road shape estimation processing may not be carried out, in order to reduce a calculation load of the CPU, for a region in which there may be a low possibility of an interference against the projected travel trajectory of the vehicle.

For example, in a case where the vehicle takes a posture of holding a straight run, only a case where the shoulder of road is present in a front zone in the forward direction of the vehicle may be extracted and the estimation of the shoulders of the road at the left side and the right side more nearly be located at the lateral side of the vehicle may be omitted.

(Point of Collision Calculation Processing)

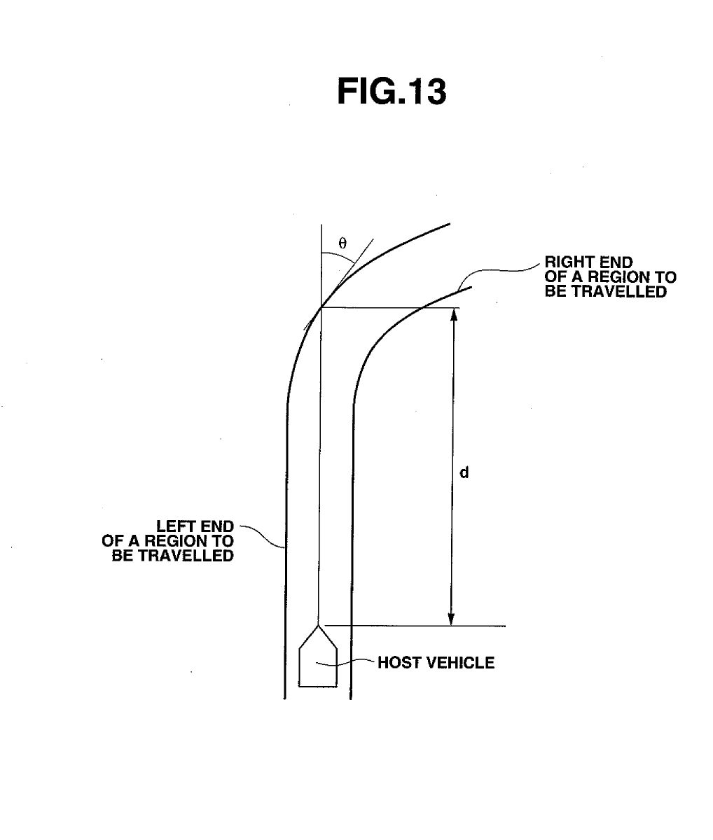

In the point of collision calculation processing, for the road region estimated through the road shape prediction processing, a distance d from the vehicle to a road region end against which the vehicle is traveling to collide and an angle θ formed between a direction of the vehicle up to the collision point and the road region end are calculated, as shown in FIG. 13. At this time, an advancing trajectory of the vehicle may be a straight line or may be a course of travel based on a predicted turning curvature calculated on a basis of one or both of the present steering angle and the yaw rate. In addition, in a case where the calculated predicted turning curvature of the vehicle is determined to be dangerous due to the present speed of the travel or any other factors, the turning curvature may be used after a correction of the turning curvature. Thus, in a case where the vehicle is turning in the same direction as the curved road, the distance to the collision becomes long. Hence, the unnecessary alarm issuance and the brake control intervention can be suppressed. On the other hand, in a case where the vehicle (host vehicle) is turning in an opposite direction to the curved road, an earlier or strong alarm issuance or brake control intervention can be carried out.

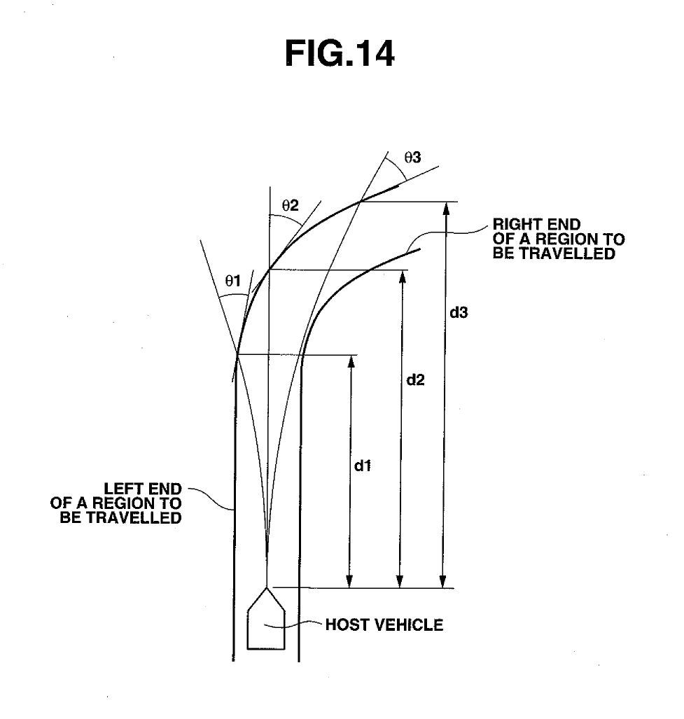

Or alternatively, as shown in FIG. 14, in three kinds of cases where, as the advancing road of the vehicle, the straight traveling, the advance of the vehicle with predetermined turning curvatures in the left-side and right-side directions is carried out, distances d1, d2, d3 from the vehicle to road region ends at which the vehicle would be collided and angles θ1, θ2, θ3 formed between the direction of the vehicle and the road shape end at the points of collisions are calculated. From among the three kinds, a longest distance may be selected as a final result. In an example of FIG. 14, since the road shape is a right curve, the distance to the region end in a case where the right turn trajectory is drawn is the longest. Hence, distance d3 is adopted as distance d to the region end and angle θ3 formed by the trajectory taken in this case and the region end is adopted as angle θ.

Thus, a determination of whether the issuance of the alarm or the brake control intervention is needed or not even if the driver would perform the steering operation which usually be predicted to be performed according to the present traveling condition is taken into consideration can be determined.

The unnecessary alarm issuance or the brake control intervention can be suppressed.

It should be noted that a case where the vehicle is supposed to be advanced, respectively, with the constant curvature in both of the left-side-and right-side directions, the curvature may always be constant, may be calculated curvature on a basis of the steering angle and the yaw rate at the present time or immediately before the present time, or may be determined by another method.

It should also be noted that the road region is basically the concept that indicates the traffic lane in which the vehicle travels but may be treated as a concept that indicates the road surface region. This is not specifically limited.

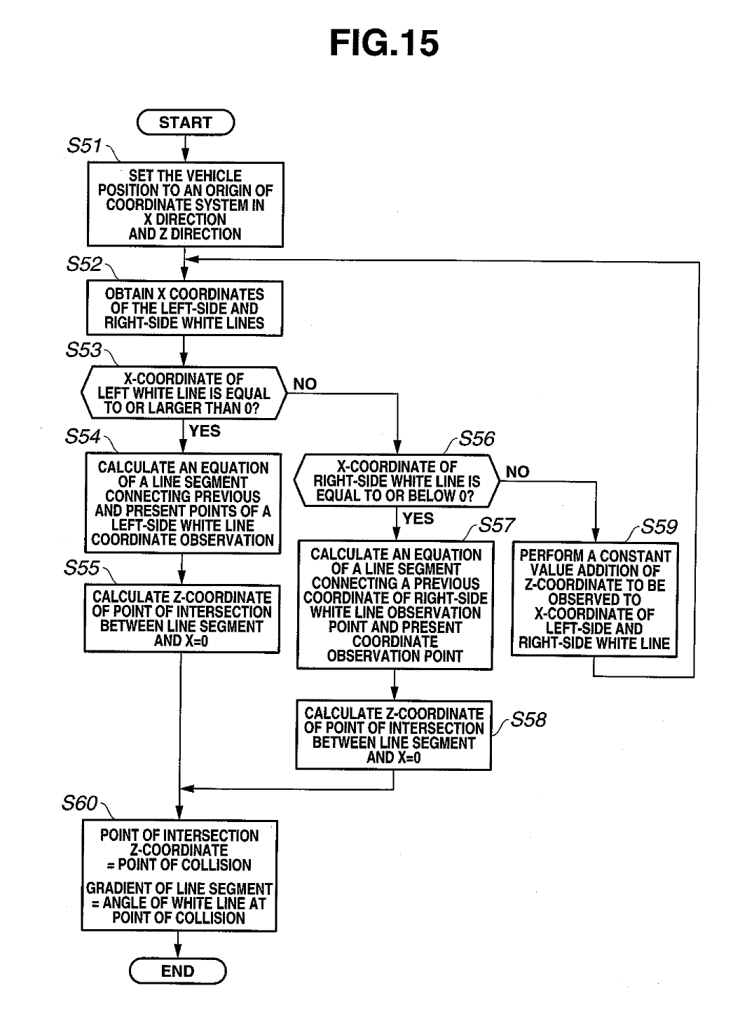

FIG. 15 shows a flowchart representing a flow of the collision point calculation processing. Each step shown in FIG. 15 will be described below.

At a step S51, control unit ECU sets the present position of the vehicle to be an origin (0, 0) of a coordinate system with an x-direction (lateral direction; right direction (as viewed from the vehicle driver's eye is positive) and z direction (forward-rearward direction (vehicular longitudinal direction, the forward direction is positive). Then, the routine goes to a step S52.

At step S52, control unit ECU obtains x-coordinate of the left-and-right side white lines and the routine goes to a step S53.

At step S53, control unit ECU determines whether the x-coordinate of the left-side white line is equal to or larger than zero. If Yes at step S53, the routine goes to a step S54. If No at step S53, the routine goes to a step S56.

At step S54, control unit ECU calculates an equation of a line segment connecting between the present coordinate observation point of the left-side white line and the present coordinate observation point and the present coordinate observation point and the present routine goes to a step S55.

At step S55, control unit ECU calculates an equation on z-coordinate of the point of intersection between the gradient of the line segment calculated at step S54 and x=0 and the routine goes to a step S60.

At step S56, control unit ECU determines whether the x-coordinate of the left-side white line is equal to or higher than zero. If Yes, the routine goes to step S57. If No at step S56, the routine goes to a step S59.

At step S57, control unit ECU calculates the equation of the line segment connecting between previous coordinate observation point of the left-side white line and the present coordinate observation point and the routine goes to a step S58.

At step S58, control unit ECU calculates the z-coordinate of the point of intersection between the gradient of the line segment calculated at step S57 and x=0 and the routine goes to a step S60.

At step S59, control unit ECU adds x-coordinates of the left-side and right-side white lines to the z-coordinate to be observed by a constant value and the routine goes to step S52.

At step S60, control unit ECU sets in the following ways: z-coordinate of the point of intersection=point of collision d, and gradient of line segment=angle θ and the present control is ended.

In a case where a right curved road is present on the traveling road of the vehicle in the forward direction, in the flowchart shown in FIG. 15, the routine goes from step S51→step S52→step S53→step S54→step S55→step S55 and passed through step S60 and sets the point of intersection connecting between the previous coordinate observation point of the left white line and the present coordinate observation point and x=0, namely, the point of intersection between x=0 and the line segment set on the traveling course of the vehicle as the point of collision d.

On the other hand, in a case where the left curved road is present on the traveling road of the vehicle in the forward direction, in the flowchart of FIG. 15, the routine goes from steps of step S51→step S52→step S53→step S56→step S57→step S58 and to step S60 and a point of intersection between the line segment connecting the previous coordinate observation point of the right-side white line and the present coordinate observation point thereof and a line segment set on the traveling route set on the advancing route of the vehicle is set as the point of collision d. It should be noted that the point of collision calculation processing may be omitted to relieve the reduction of the calculation of the CPU.

(Result Output Processing)

In the result output processing, as an output of the road shape estimation result, distance d by which the vehicle would collide against the road region end, and angle θ formed by both of the road region end and the advancing road of the vehicle are outputted.

Thus, a grasping of a road environment that the vehicle driver usually carries out through a visual recognition by the vehicle driver and the alarm issuance which matches with the driving operation based on the grasping of the road environment can be carried out and the corresponding alarm issuance gives an unpleasant feeling to the vehicle driver can be relieved.

(Brake Control Processing)

In the brake control processing, an appropriate vehicle speed at the point of collision is, at first, calculated in accordance with the road shape. For example, in the case of the vehicular traveling on the curved road, an appropriate vehicle speed is preset in accordance with the curvature of the curved road when the vehicle is traveling on the curved road to obtain the vehicle speed which meets with the road shape. In the calculation of the appropriate vehicle speed, the determination of the appropriate vehicle speed may be made with various factors such as the presence or absence of an oncoming vehicle and its speed and its position, a presence or absence of a preceding vehicle, its speed, and its position, a traffic congestion information of the traveling road or a situation under which the road end is constituted (a possibility of a deviation from the road end such as presence of the curb or so forth). Subsequently, when, with the appropriate vehicle speed as a target vehicle speed, the appropriate vehicle speed is compared with the present vehicle speed, the brake control utilizing BBW system and utilizing the engine brake when the present vehicle speed is higher than the target vehicle speed is carried out. Or alternatively, a message or an output of a speech sound to alarm the excess of a limit vehicle speed to the vehicle driver is carried out. Such an alarm as described above may be carried out simultaneously together with the brake control and the alarming. As described above, in a case where the acceleration intention of the vehicle driver is detected, namely, in a case where the vehicle driver depresses an accelerator pedal AP, the above-described brake control is not carried out (suppressed) and a higher priority is placed on the acceleration intention of the vehicle driver. However, only the alarm may be carried out.

On the other hand, in a case where the target vehicle speed is higher than the present vehicle speed, such a information that the acceleration is improved than an ordinary acceleration when the driver carries out the acceleration operation and that the driver can drive the vehicle in safety may be carried out. In addition, in a case where the target vehicle speed is equal to or higher than the present vehicle speed, under a situation that the driver separates from accelerator pedal AP. Under this situation, the action of the engine braking is relieved so that the deceleration is relieved from the ordinary traveling state or the deceleration may not be carried out. It should, herein, be noted that to maintain the vehicle speed against a traveling resistance, an output of engine E may appropriately be improved.

A target deceleration G to transfer present vehicle speed V1 to a target vehicle speed V2 is derived from the following equation (2) with a control time as t.

G=(V1²−V2²)/2t (2)

It should, herein, be noted that control time t may be a fixed value or may be varied in accordance with such a factor of a difference between the present vehicle speed V1 and target vehicle speed V2 and an upper limit of the target deceleration may be provided in the viewpoint of a safety and a driving comfort, It should also be noted that in a case where the brake control is executed, the acceleration or deceleration may be varied in accordance with a road gradient situation measured or estimated from traveling environment recognition apparatus 1.

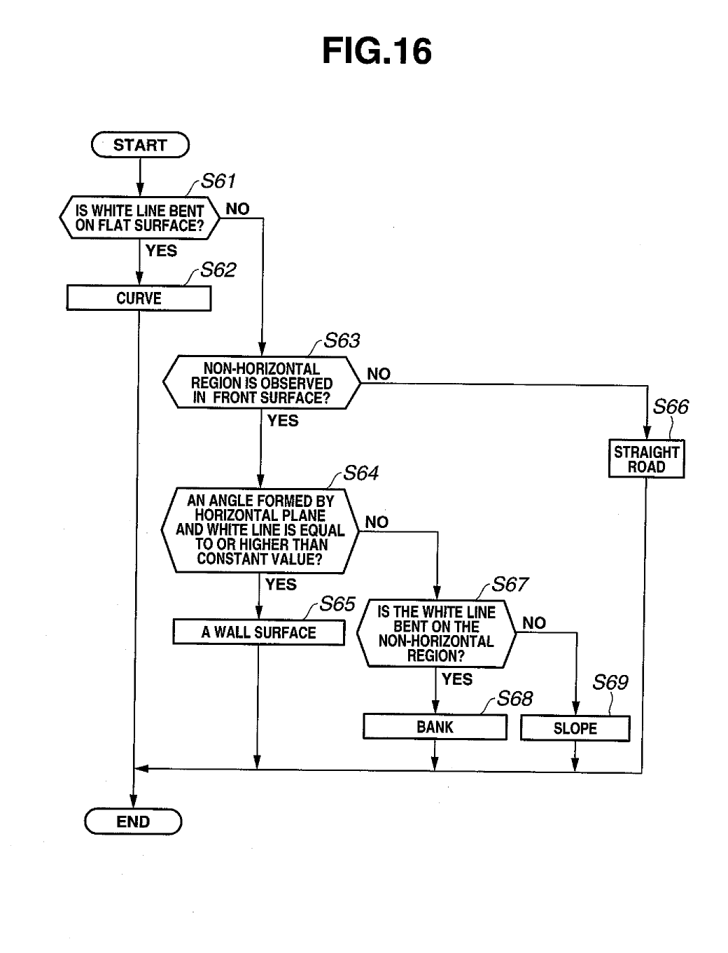

FIG. 16 shows a flowchart representing a flow of the road shape determination processing utilizing that the white line data has a three-dimensional space positional information.

At a step S61, control unit ECU determines whether the white line is bent on a plane. If Yes, the routine goes to a step S62. If No at step S61, the routine goes to a step S63.

At step S62, control unit ECU determines that the curved road (the road shape is a curve) and the present routine is ended.

At step S63, control unit ECU determines whether the region which is not horizontal has been observed at the front side. If Yes at step S63, the routine goes to a step S64. If No at step S63, the routine goes to a step S66.

At step S64, control unit ECU determines whether an angle formed by the region which is not horizontal and a horizontal plane is equal to or wider than a constant value.

If Yes at step S64, the routine goes to a step S65.

If No at step S64, the routine goes to a step S67.

At step S65, the control unit ECU determines that the road shape is a wall surface and the present routine is ended.

At step S66, the control unit ECU determines that the road shape is the straight road and the present routine is ended.

At step S67, control unit ECU determines whether the white line is bent on a region which is not horizontal.

If Yes, the routine goes to a step S68. If No at step S67, the routine goes to a step S69.

At step S68, control unit ECU determines the road shape is a bank and the present routine is ended.

At step S69. control unit ECU determines a gradient road (or a slope) and the present routine is ended.

Next, an action of the control apparatus for the vehicle in which traveling environment recognition apparatus 1 is installed will be described hereinafter.

A previously proposed vehicle control apparatus includes an adaptive cruise control (ACC) system in which the speed of the vehicle is controlled in accordance with the vehicle speed of the preceding vehicle using a laser radar or so forth and which has already been put into practice. Furthermore, recently, another type of ACC system has been developed in which the curvature of the curved road located in forward direction of the vehicle is calculated on a basis of the range of node points obtained from the data base of the navigation system and automatically decelerated at the curved road as described in the BACKGROUND OF THE INVENTION. In the way described above, in a system in which the brake control or the alarm issuance is carried out on the basis of the information of the road shape and so forth in addition to the traveling state of the vehicle, a control accuracy is largely dependent upon the information of the road map data base of the navigation system. Hence, in a case where an error between the curve calculated from the range of node points and the actual road shape is present or in a case where the road shape itself is changed due to a construction or so forth, a timing at which the brake control or the alarm issuance is carried out does not coincide with an optimum timing. Thus, the driver gives an unpleasant feeling. Under these circumferences, the technique in which the road shape is measured and estimated with a high accuracy on a real time has been demanded.

On the other hand, in the vehicle control apparatus in the first embodiment, traveling environment recognition apparatus 1 which predicts the road shape of the traveling road in the forward direction of the vehicle on a real time from the positional information of the white line and the three-dimensional body obtained by the stereo cameras (cameras 103, 104). Hence, the brake control and the issuance of the alarm can be made at the most appropriate timing in accordance with the road shape at an optimum timing.

Furthermore, since, the stereo camera obtains the three dimensional information which is discernable in a rise and fall of road, kinds of the cubic object located aside of the road, the number of traffic lanes, and so forth. In addition, in traveling environment recognition apparatus 1, the white line detection points having a low reliability are eliminated from the detected white line detection range of node points and the part of the white line having the low reliability is complemented on a basis of the range of the white line detection points having the high reliability. Hence, the road shape can be predicted with the high reliability.

Next, advantages of the traveling environment recognition apparatus 1 and vehicle control apparatus will be described hereinbelow.

(1) The vehicle control apparatus includes: traveling road state detection section 9 configured to detect the state of the traveling road in the forward direction of the vehicle; object recognition section 10 configured to recognize at least a presence of the object on the traveling road from the detection result of traveling road state detection section 9; road shape prediction section 8 configured to predict the road shape of the traveling road in the forward direction of the vehicle; travel trajectory prediction section configured to project the travel trajectory; point of intersection calculation section 3 configured to calculate a point of intersection between the road end of the road projected by the road shape prediction section 8 and the trajectory projected by the travel trajectory prediction section 8; and vehicle control section 5 configured to control the vehicle speed with the point of intersection calculated by the point of intersection calculation section 3 as a target point of place (the point of collision).

That is to say, in a vehicle speed control apparatus in the first embodiment, the object on the traveling road is detected and recognized, the road shape in the forward direction of the traveling road of the vehicle is predicted, and the road shape on the traveling road in the forward direction of the vehicle is determined on a basis of the detection result and the prediction result. Thus, the vehicular speed is controlled on a basis of the predicted road shape with the high accuracy. Consequently, the vehicle control with the high accuracy can be achieved.

(2) Traveling road state detection section 9 is a stereo camera having two cameras 103, 104. Object recognition section 10 recognizes the object according to parallax δ of the photographed images photographed by means of respective cameras 103, 104. Therefore, since the positional information on the three dimensional space of the object can be recognized, the vehicle control with the gradient of the road surface such as the slope or the bank taken into consideration can be achieved.

(3) The traveling road state detection section 9 includes the object of deceleration detection section 11 configured to detect an object of deceleration of the vehicle. Vehicle speed control section 5 calculates target deceleration G from the present vehicle speed V1, target vehicle speed V2, and control time t in a case where the object of deceleration is detected by means of object of deceleration detection section 11 and the deceleration control to automatically decelerate the vehicle according to the calculated target deceleration G is carried out. Thus, the deceleration control with the high accuracy can be achieved.

(4) Acceleration intention detection section 4 is installed to detect the acceleration intention by the vehicle driver and vehicle control section 5 does not carry out (inhibits) the deceleration control when acceleration intention detection section 4 detects the acceleration intention even if the object of deceleration is detected by the object of deceleration detection section 11. For example, suppose that, in a case where the vehicle is decelerated when the driver depresses accelerator pedal AP, the vehicle is decelerated. In this case, the unpleasant feeling is given to the vehicle driver. Thus, when the vehicle driver's acceleration intention is detected, the deceleration control which copes with the intention of the vehicle driver can be achieved since no deceleration control is carried out.

(5) Reliability determination section 7 is provided to determine the reliability of the recognition result by object recognition section 10. Road shape prediction section 8 predicts the road shape of the traveling road in the forward direction of the (host) vehicle in a case where the reliability coefficient determined by the reliability determination section 7 is equal to or lower than the predetermined threshold value. That is to say, in a case where the reliability of the result of recognition is high, the prediction of the road shape is not necessary. In this case, the prediction of the road shape is not carried out so that the calculation load on the CPU of control unit ECU can be reduced.

(6) Road shape prediction section 8 predicts the road shape on a basis of the object information of the object whose reliability coefficient is equal to or higher than the predetermined threshold value. In other words, in a case where the road shape is predicted on a basis of the object information whose reliability is low, a separation between the predicted road shape and the actual road shape occurs. To cope with this, the road shape is predicted only using the object information having the high reliability so that the prediction accuracy can be increased.

(7) Road shape prediction section 8 predicts the road shape on a basis of the three-dimensional body located aside of the road and the white line. Since the three-dimensional body usually located aside the vehicle (the curb, the tree, the guard rail, the marker, and so forth) is arranged in parallel to the road and offset from the road by a constant width, the road shape is predicted from these cubic bodies located aside the road. Thus, the prediction accuracy can be increased.

(8) Road shape prediction section 8 predicts the road shape on a basis of a curvature of the white line painted on the road. Since the white line is painted along the road, the curvature of the white line can be viewed so that the curvature of the road can be grasped. Thus, the prediction accuracy of the road shape can be increased.

(9) Road shape prediction section 8 predicts the road shape on a basis of a gradient of the white line painted on the road. Since the white line is painted on the road, the gradient of the road can be viewed so that the gradient of the road can be grasped.

(10) Road shape prediction section 8 corrects the distance to the three-dimensional body in the forward direction of the vehicle in which the vehicle is advancing on a basis of the three-dimensional body and the white line and predicts the road shape on a basis of the result of correction. Hence, the road shape can be predicted with the high accuracy.

(11) Traveling environment recognition apparatus 1 includes: road state recognition section 6 configured to recognize the presence of the object by detecting the white line on the traveling road in the forward direction of the vehicle; and reliability determination section 7 configured to determine the reliability of the result of recognition by the road state recognition section 6; and road shape prediction section 8 configured to project the road shape of the traveling road in the forward direction of the vehicle on a basis of an information by the road state recognition section 6 in a case where the reliability determined by reliability determination section 7 is equal to or lower than the predetermined reliability. That is to say, the white line on the traveling road or the object located aside the road is detected and predicted and a part of the road shape whose reliability is low is predicted on a basis of the result of recognition of the object having the high reliability. Hence, the road shape can be predicted with high reliability.

(12) The vehicle control apparatus includes traveling environment recognition apparatus 1; a travel trajectory prediction section 2 configured to predict a travel trajectory of the vehicle; a point of intersection projection section 3 configured to calculate a point of intersection between the predicted road end of the road projected by road shape prediction section 8 and the trajectory predicted by travel trajectory prediction section 2; and vehicle control section 5 configured to control the speed of the vehicle as the point of intersection between the point of intersection calculated by the point of intersection calculation section 3 as the target point of place. Thus, the vehicle speed can be controlled on a basis of the road shape predicted with the high accuracy. Consequently, the vehicle control with the high accuracy can be achieved.

(13) Traveling environment recognition apparatus 1 includes road shape prediction section 8 configured to predict the road shape on a basis of the stereo camera (cameras 103, 104) photographing at least the white line located on the traveling road in the forward direction of the (host) vehicle; and a road shape prediction section 8 configured to predict the road shape on a basis of the curvature or the gradient of the white line photographed by the stereo camera. The road shape is determined on a basis of the photographed image photographed by the stereo camera and the result of recognition by road shape prediction section 8. Thus, the road shape can be determined on a basis of the positional information of the white line on the three-dimensional space. Thus, the vehicle control can be achieved with the road surface gradient such as those of slope and bank taken into consideration.

The vehicle control apparatus includes: the point of intersection calculation section configured to calculate the point of intersection between the road end of the road projected by the road shape projection section 8 and the trajectory predicted by trajectory prediction section 2; and vehicle control section 5 configured to control the speed of the vehicle with the point of intersection calculated by the point of intersection calculation section 3 as the target point of place. Road shape prediction section 8 includes the object of deceleration detection section 11 configured to detect the object of deceleration of the vehicle and vehicle control section 5 calculates target deceleration G from present vehicle speed V1, target vehicle speed V2 of the target point of place, and control time t in a case where the object of deceleration is detected by the object of deceleration detection section 11 and executes the deceleration control which automatically decelerates the vehicle according to calculated target deceleration G. Thus, the deceleration control with the high accuracy can be achieved.

### Other Preferred Embodiments

Hereinafter, the preferred embodiments to carry out the present invention will be explained on a basis of the first embodiment described above. The specific structure of the present invention is not limited to the first embodiment described above.

For example, in the first embodiment, two cameras 103, 104 are used as the traveling state detection section configured to detect the state of the traveling road in the forward direction of the vehicle. The traveling state detection section may be constituted by a single camera, laser radar, millimeter wavelength radar, ultra-sonic sensor, or a combination thereof. For example, a to combination of a monoscopic camera with the laser radar, the monoscopic camera detecting the traffic lane and laser radar detecting the three-dimensional body, thus substantially constituting the traveling state detection section in the first embodiment.

In the first embodiment, as the alarm, the display through display DSP and the alarm issuance through speaker SPK are carried out.

However, either one of the display or the alarm issuance may be used. It should be noted that, as the alarm means (section), an actuator which vibrates a portion of contacting with the vehicular occupant such as a seat belt, brake pedal BP, accelerator pedal AP, the steering wheel, the seat, and so forth may be installed. In the example in the first embodiment, cameras 103, 104 are installed in front of the vehicle but these cameras may be installed in a proximity to a room mirror located in a front direction of a vehicular passenger compartment.

Next, technical concepts other than those described in the claims will be described hereinbelow.

(1) A control method for a vehicle in which a traveling environment recognition apparatus is installed, the control method comprising: detecting a state of a traveling road in a forward direction of the vehicle; recognizing at least a presence of an object on the traveling road from a detection result of the traveling road state detection; predicting a road shape of the traveling road in the forward direction of the vehicle on a basis of a result of recognition by the object recognition; predicting a travel trajectory of the vehicle; calculating a point of intersection between a road end of the road predicted by the road shape prediction and a trajectory predicted by the travel trajectory prediction; and controlling a speed of the vehicle, with the point of intersection calculated by the point of intersection calculation as a target point of place.

(2) A control apparatus for a vehicle in which a traveling environment recognition method is installed, wherein the traveling environment recognition method comprises: recognizing a presence of a white line or an object located aside a traveling road in a forward direction of the vehicle; determining a reliability of a result of recognition by the road state recognition; and predicting a road shape on the traveling road located in the forward direction of the vehicle on a basis of the information from the road state recognition in a case where the reliability determined by the reliability determination is lower than a predetermined reliability.

(3) A control apparatus for a vehicle in which a traveling environment recognition method is installed, wherein the traveling environment recognition method comprises: providing a stereo camera configured to photograph at least a white line present on a traveling road in a forward direction of the vehicle; predicting a road shape on a basis of a curvature or gradient of the white line photographed by the stereo camera; and

predicting the road shape on a basis of an image photographed by the stereo camera and a result of prediction by the road shape prediction.

This application is based on a prior Japanese Patent Application No. 2009-072618 filed in Japan on Mar. 24, 2009. The entire contents of this Japanese Patent Application No. 2009-072618 are hereby incorporated by reference. Although the invention has been described above by reference to certain embodiments of the invention, the invention is not limited to the embodiment described above. Modifications and variations of the embodiments described above will occur to those skilled in the art in light of the above teachings. The scope of the invention is defined with reference to the following claims.

What is claimed is:

1. A control apparatus for a vehicle in which a traveling environment recognition apparatus is installed, comprising:
a traveling road state detection section configured to detect a state of a traveling road in a forward direction of the vehicle;
an object recognition section configured to recognize at least a presence of an object on the traveling road from a detection result of the traveling road state detection section;
a road shape prediction section configured to predict a road shape of the traveling road in the forward direction of the vehicle on a basis of a result of recognition by the object recognition section;
a travel trajectory predicting section configured to predict a travel trajectory of the vehicle;
a point of intersection calculation section configured to calculate a point of intersection between a road end of the road predicted by the road shape prediction section and a trajectory predicted by the travel trajectory prediction section; and
a speed control section configured to control a speed of the vehicle, with the point of intersection calculated by the point of intersection calculation section as a target point of place.

2. The control apparatus for the vehicle in which the traveling environment recognition apparatus is installed as claimed in claim 1, wherein the traveling road state detection section comprises a stereo camera in which at least two cameras are installed and wherein the object recognition section recognizes the object according to a parallax of a photographed image photographed by means of the respective cameras.

3. The control apparatus for the vehicle in which the traveling environment recognition apparatus is installed as claimed in claim 1, wherein traveling road detection section comprises an object of deceleration detection section configured to detect an object of deceleration for the vehicle and wherein the vehicle control section is configured to calculate a target deceleration from a present vehicle speed and from the target point of place and configured to execute a deceleration control to automatically decelerate the vehicle according to the calculated target deceleration.

4. The control apparatus for the vehicle in which the traveling environment recognition apparatus is installed as claimed in claim 3, wherein the control apparatus further comprises an acceleration intention detection section configured to detect an acceleration intention of a vehicle driver and wherein the vehicle control section inhibits the deceleration control when the acceleration intention detection section detects the acceleration intention of the driver, even if the object of deceleration is detected by the object of deceleration detection section.

5. The control apparatus for the vehicle in which the traveling environment recognition apparatus is installed as claimed in claim 1, wherein the control apparatus further comprises a reliability determination section configured to determine a reliability of a result of recognition by the object recognition section and wherein the road shape prediction section predicts the road shape in a case where the reliability determined by the reliability determination section is lower than a predetermined reliability.

6. The control apparatus for the vehicle in which the traveling environment recognition apparatus is installed as claimed in claim 5, wherein the road shape prediction section predicts the road shape on a basis of an object information equal to or higher than a predetermined reliability.

7. The control apparatus for the vehicle in which the traveling environment recognition apparatus is installed as claimed in claim 6, wherein the object is a white line painted on the traveling road and the road shape prediction section predicts the road shape on a basis of a curvature of a white line having a reliability equal to or higher than a predetermined threshold value.

8. The control apparatus for the vehicle in which the traveling environment recognition apparatus is installed as claimed in claim 6, wherein the object is a white line painted on the traveling road and wherein the road shape prediction section predicts the road shape on a basis of a gradient of a white line having a reliability equal to or higher than a predetermined threshold value.

9. The control apparatus for the vehicle in which the traveling environment recognition apparatus is installed as claimed in claim 6, wherein the object includes a three-dimensional body located aside the road and a white line painted on the traveling road and wherein the road shape prediction section predicts the road shape on a basis of the three-dimensional body located aside the road and the white line.

10. The control apparatus for the vehicle in which the traveling environment recognition apparatus is installed as claimed in claim 9, wherein the road shape prediction section corrects a distance to the three-dimensional body located in the forward direction of the vehicle and predicts the road shape on a basis of the information on the three-dimensional body and the white line.

11. A control apparatus for a vehicle in which a traveling environment recognition apparatus is installed, wherein the traveling environment recognition apparatus comprises: a road state recognition section configured to recognize a presence of a white line or an object located aside a traveling road in a forward direction of the vehicle; a reliability determination section configured to determine a reliability of a result of recognition by the road state recognition section; and a road shape prediction section configured to predict a road shape on the traveling road located in the forward direction of the vehicle on a basis of the information from the road state recognition section in a case where the reliability determined by the reliability determination section is lower than a predetermined reliability.

12. A control apparatus for a vehicle in which a traveling environment recognition apparatus is installed, wherein the traveling environment recognition apparatus as claimed in claim 11 and wherein the control apparatus comprises: a travel trajectory prediction section configured to predict a travel trajectory of the vehicle; a point of intersection calculation section configured to calculate a point of intersection between a road end of the road predicted by the road shape prediction section and the projected trajectory by the travel trajectory prediction section; and a control section configured to control the speed of the vehicle with the point of intersection calculated by the point of intersection calculation section as a target point of place.

13. The control apparatus for the vehicle in which the traveling environment recognition apparatus is installed, as claimed in claim 12, wherein the control apparatus further comprises a stereo camera in which at least two cameras are installed and wherein the road state recognition section recognizes the object according to a parallax of the photographed image photographed by the respective cameras.

14. The control apparatus for the vehicle in which the traveling environment recognition apparatus is installed, as claimed in claim 13, wherein the road state recognition section comprises an object of deceleration detection section configured to detect an object of deceleration detection section and wherein the vehicle control section calculates a target deceleration from a present vehicle speed and the target point of place and configured to perform a deceleration control to automatically decelerate the vehicle according to the calculated target deceleration.

15. The control apparatus for the vehicle in which the traveling environment recognition apparatus is installed, as claimed in claim 14, wherein the control apparatus further comprises an acceleration intention detection section configured to detect an acceleration intention by a vehicle driver and wherein the vehicle control section inhibits an execution of the deceleration control when the acceleration intention by the vehicle driver is detected by the acceleration intention detection section even when the object of deceleration is detected by the object of deceleration detection section.

16. The control apparatus for the vehicle in which the traveling environment recognition apparatus is installed, as claimed in claim 15, wherein the road shape prediction section predicts the road shape on a basis of an object information equal to or higher than a predetermined reliability.

17. The control apparatus for the vehicle in which the traveling environment recognition apparatus is installed, as claimed in claim 16, wherein the object is a white line painted on the traveling road and wherein the road shape prediction section predicts a road shape on a basis of a curvature or a gradient of the white line having a considerably high reliability.

18. The control apparatus for the vehicle in which the traveling environment recognition apparatus is installed, as claimed in claim 11, wherein the object includes a three-dimensional body located aside a road and a white line photographed by the stereo camera and wherein the road shape prediction section corrects a distance from the vehicle to the solid body located in the forward direction of the vehicle on a basis of the information of the three-dimensional body and the white line and predicts the road shape on a basis of a result of correction.

19. A control apparatus for a vehicle in which a traveling environment recognition apparatus is installed, wherein the traveling environment recognition apparatus comprises: a stereo camera configured to photograph at least a white line present on a traveling road in a forward direction of the vehicle; a road shape prediction section configured to predict a road shape on a basis of an image photographed by the stereo camera and wherein the road shape prediction section predicts the shape of the road on a basis of an image photographed by the stereo camera and a result of prediction by the road shape prediction section.

20. A control apparatus for a vehicle in which a traveling environment recognition apparatus is installed, wherein the control apparatus comprises: the traveling environment recognition as claimed in claim 19; a point of intersection calculation section configured to calculate a point of intersection between an end of the road predicted by the road shape prediction section and a trajectory predicted by a travel trajectory prediction section; and a speed control section configured to control a speed of the vehicle with a point of intersection calculated by the point of intersection calculation section as a target point of place, wherein the road shape prediction section includes an object of deceleration detection section configured to detect an object of deceleration and the speed control section executes a deceleration control to calculate a target deceleration from a present vehicle speed and the target point of place in a case where the object of deceleration is detected by the object of deceleration detection section.
